(19) United States
(12) Patent Application Publication
(10) Pub. No.: US 2006/0044947 A1
(43) Pub. Date: Mar. 2, 2006

(54) Headrest type media player device

(76) Inventor: Chung-Wu Chia, Taipei County (TW)

Correspondence Address: Rightech Corporation, P. O. Box No. 6-57, Junghe, Taipei, 235, TW

(21) Appl. No.: 10/918,435

(22) Filed: Aug. 16, 2004

(51) Int. Cl. G11B 19/00

(52) U.S. Cl. 369/29.02

(57) ABSTRACT

A headrest type media player device includes a liquid crystal panel, an indicator light, a card reader, a plug & play slot, a compact disk reader slot and a power cord. The card reader fixedly configured below the liquid crystal panel thereby displaying contents of data read. The card reader can read ROM cards having a plurality of specifications, for instance, a mobile disk, a digital camera memory card, a game ROM card, and so on. A user is able to replace and view whatever compact disc by utilizing the compact disc reader slot. The media device body is fixedly mounted interior of a headrest, thereby achieving effectiveness of reducing space required. The compact disc reader slot can read discs having a plurality of formats, for instance, DVD, VCD, and so on, thereby achieving effectiveness of product diversification, entertainment value and convenience.

### BACKGROUND OF THE INVENTION

(a) Field of the Invention

The present invention relates to a headrest type media player device, and more particularly to a media player device having a primary function to read a ROM card by means of a card reader, and which is able to play a movie a user wishes to view by reading different types of ROM cards or in accordance with user requirements, thereby achieving effectiveness of product diversification, personalization and practicability.

(b) Description of the Prior Art

According to conventional art, a headrest player device is generally only able to play VCD or DVD discs, moreover, a movie is necessarily broadcasted by means of a host disc player, which brings about impractical shortcomings.

Furthermore, when other multi-media player devices are simultaneously playing the movie being broadcasted by the host disc player (see FIG. 1), other terminals are only able to play the movie designated by the host disc player. Upon a user wishing to view another movie, the user is unable to utilize the media player to view a movie to their liking, and is often an area for criticism by the user.

### SUMMARY OF THE INVENTION

Referring to all accompanying FIGS. 1, 2, 3 and 4, the present invention is structured to comprise a liquid crystal panel 4, an indicator light 5, a card reader 6, a compact disk reader slot 8 and a power cord 9. Referring to FIG. 2, which shows the liquid crystal panel 4 embedded in a front portion of a media device body 3. The liquid crystal panel 4 is utilized to display contents of data read. The indicator light 5 is configured close to the liquid crystal panel 4, and functions to indicate whether or not electric power is being supplied or, when reading data, indicates whether or not there is data to read. Furthermore, the card reader 6 is fixedly configured below the liquid crystal panel 4, and is able to read data stored within a ROM card 12, moreover, the card reader 6 is able to read different data according to the different ROM cards 12 inserted within the card reader 6, for instance, a digital camera ROM card 12, and so on. The compact disc reader slot 8 is embedded in the media device body 3, and a user is able to replace and view whatever compact disc in accordance with preference of the user by utilizing the compact disc reader slot 8. Furthermore, the power cord 9 passes through an underside of the media device body 3, and electric power is supplied therewith, which thereby realizes activating a headrest type media player device of the present invention (see FIGS. 2 and 3).

In addition, the media device body 3 is fixedly mounted interior of a headrest 10 (see FIG. 3), thereby accomplishing effectiveness of reducing space required, and achieving objective of diversification, personalization and practicability.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional host disc player and terminals system.

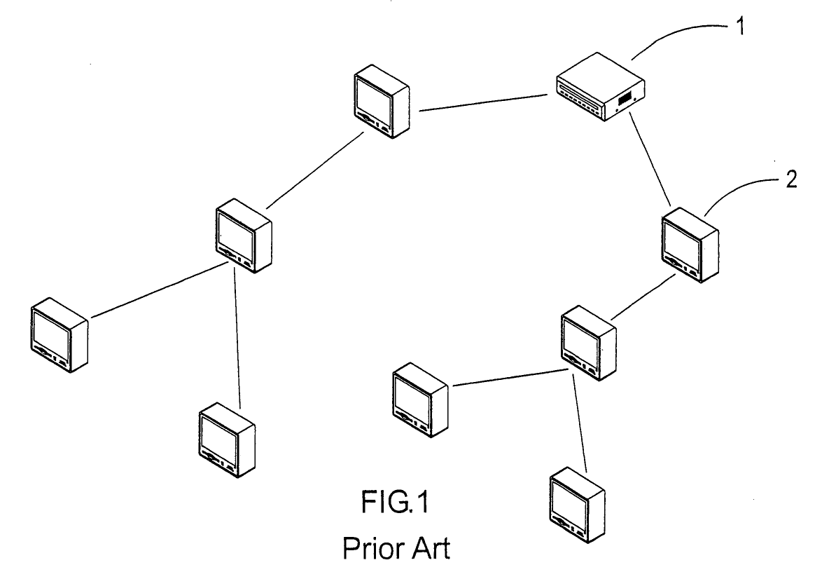

FIG. 2 shows a schematic elevational view of a headset type media player device according to the present invention.

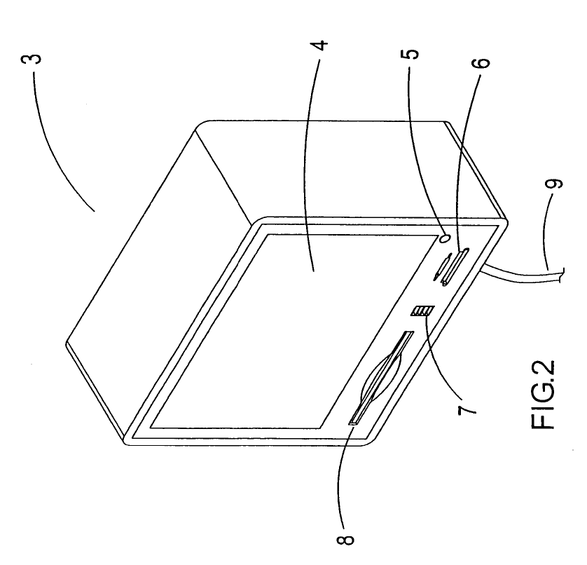

FIG. 3 shows an exploded elevational view of the headset type media player device according to the present invention.

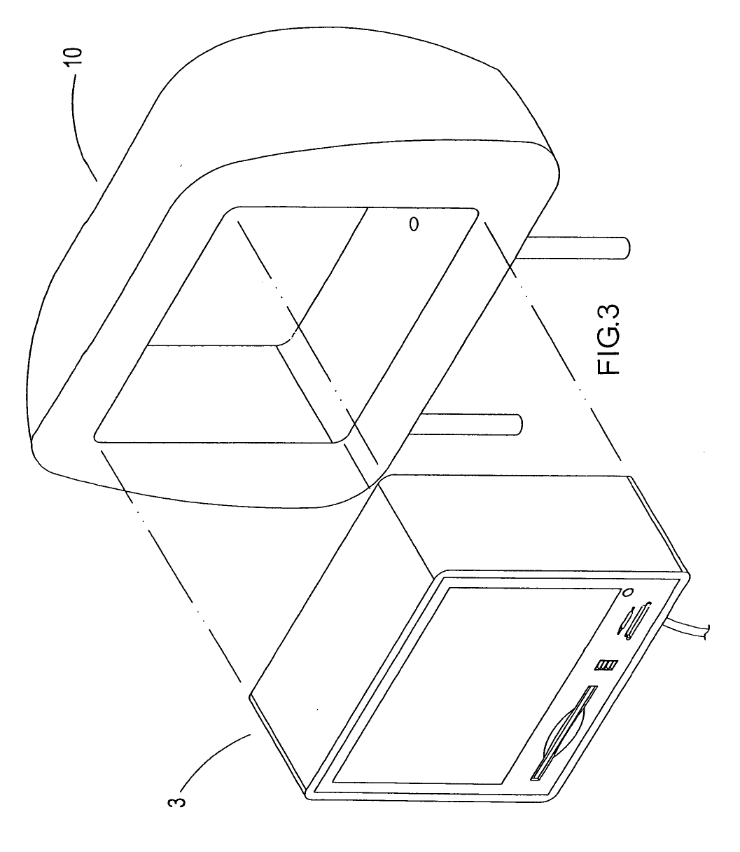

FIG. 4 shows a schematic view of an embodiment of the headset type media player device according to the present invention.

### DETAILED DESCRIPTION OF THE PREFERRED EMBODIMENTS

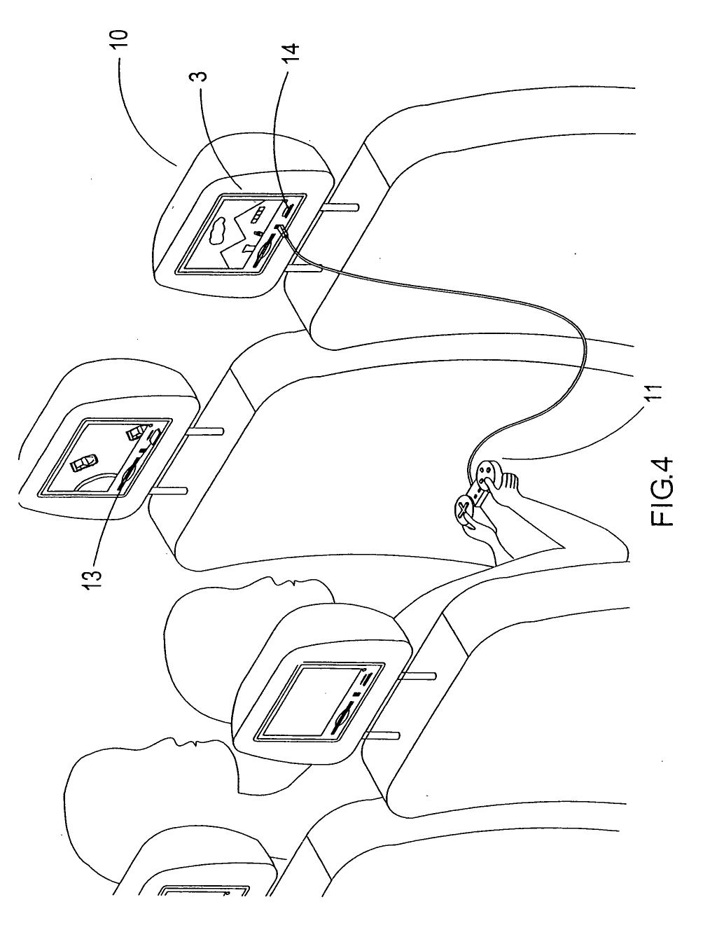

The present invention provides a headrest type media player device. Referring to FIG. 4, when wishing to use the headrest type media player device, a power supply is first actuated, whereafter, a user inserts a ROM card 12 that the user wishes to view into a card reader 6, which thereby effectuates reading of data stored within the ROM card 12.

Furthermore, after actuating the power supply, and after inserting a VCD or DVD disc that the user wishes to view into a compact disc reader 8, the user is thus able to view a movie stored on the VCD or DVD disc. Moreover, when wishing to view another ROM card, for instance, a game ROM card 13 or a digital camera ROM card 14, and so on, the present invention is configured with a plug & play slot 7 to accommodate such. In addition, the plug & play slot 7 can be configured to accommodate inserting of peripheral equipment, for instance, a game joystick 11, thereby achieving objective of providing entertainment and enjoyment.

In order to better explicitly disclose diversification, personalization and practicability of the present invention, a comparison with conventional art is described hereinafter:

### SHORTCOMINGS OF CONVENTIONAL ART

1. Limited to playing a single movie in step with the host disc player.

2. Unable to accommodate personal requirements of the user.

3. Limiting to viewing VCD or DVD discs.

### ADVANTAGES OF THE PRESENT INVENTION

1. Able to read files available in a multitude of formats according to different ROM cards inserted into the card reader.

2. Enhances practicability and convenience of the headset type media player device.

3. Capable of playing whatever movie the user chooses to view.

4. Embodies operating usage value.

In conclusion, the present invention in surmounting structural shortcomings of prior art has assuredly achieved effectiveness of anticipated advancement, and moreover, is easily understood by persons unfamiliar with related art. Furthermore, contents of the present invention have not been publicly disclosed prior to this application, and advancement and practicability of the present invention comply with essential elements as required for application of a new patent model. Accordingly, a new patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A headrest type media player device comprising a liquid crystal panel, an indicator light, a card reader, a plug & play slot, a compact disk reader slot and a power cord, wherein the liquid crystal panel is embedded in a front portion of a media device body, and the liquid crystal panel is utilized to display contents of data read; the card reader is fixedly configured below the liquid crystal panel, and the card reader is able to read data stored within ROM cards; the compact disc reader slot is embedded in the media device body, moreover, a user is able to replace and view whatever compact disc in accordance with preference of the user by utilizing the compact disc reader slot, the media device body is fixedly mounted interior of a headrest, thereby achieving effectiveness of reducing space occupied.

2. The headrest type media player device according to claim 1, wherein the card reader can read ROM cards having a plurality of specifications, for instance, a mobile disk, a digital camera memory card, a game ROM card, and so on.

3. The headrest type media player device according to claim 1, wherein the plug & play slot can be additionally configured in the headrest type media player device, and, moreover, the plug & play slot can be configured to accommodate inserting of peripheral equipment, for instance, a game joystick, and so on.
